(19) United States
(12) Patent Application Publication
(10) Pub. No.: US 2011/0058538 A1
(43) Pub. Date: Mar. 10, 2011

(54) HAND-HELD ELECTRONIC DEVICE AND COMMUNICATION METHOD APPLICABLE THERETO

(75) Inventor: Yueh-Ching HSU, Taipei (TW)

(73) Assignee: INVENTEC APPLIANCES CORP., Taipei (TW)

(21) Appl. No.: 12/879,789

(22) Filed: Sep. 10, 2010

(30) Foreign Application Priority Data
Sep. 10, 2009 (TW) 098130587

(51) Int. Cl. H04W 4/00; H04W 88/02; H04W 92/10

(52) U.S. Cl. 370/338; 455/557; 455/41.2

(57) ABSTRACT

A hand-held electronic device and a communication method applicable thereto. The hand-held electronic device includes a microprocessor and a modem unit. The microprocessor connects the hand-held electronic device with at least one first external device via an ad-hoc network protocol. The modem unit connects with a base station for enabling the first external device to communicate with the base station via the hand-held electronic device.

This application claims the benefit of Taiwan application Serial No. 98130587, filed Sep. 10, 2009, the subject matter of which is incorporated herein by reference.

### BACKGROUND OF THE INVENTION

1. Field of the Invention

The invention relates in general to a hand-held electronic device or a mobile electronic device and a communication method applicable thereto, and more particularly to a hand-held electronic device or a mobile electronic device with broadband sharing function and a communication method applicable thereto.

2. Description of the Related Art

The mobile communication industry is booming globally, and convenient mobile communication networks have become available to the consumers via for example hand-held electronic devices or mobile electronic devices. The mobile electronic device or the hand-held electronic device is hereinafter collectively called the hand-held electronic device. Furthermore, if the mobile broadband Internet service provided by the telecommunications industry is also available, the consumers can have Internet access anywhere and anytime via the hand-held electronic devices. Also, the computers can be connected to the Internet via the hand-held electronic devices. Examples of the hand-held electronic device include mobile phones, personal digital assistance (PDA) and so on.

Conventional hand-held electronic devices can only enable one computer to be connected to the Internet at one time, and cannot enable multiple computers to be connected to the Internet at the same time. Therefore, it is still not popular for the households or the workplaces, which normally have more than one computer, to replace the existing cable broadband Internet access by the mobile broadband Internet access of hand-held electronic device. In consequence, the consumers cannot use more convenient Internet access at lower cost.

Therefore, how to provide Internet access to multiple computers by a hand-held electronic device so as to reduce the cost of Internet access and increase the convenience in anywhere and anytime Internet access has become a prominent task for the industries.

### SUMMARY OF THE INVENTION

Embodiments of the invention include a hand-held electronic device or a mobile electronic device and a communication method applicable thereto. The mobile electronic device or the hand-held electronic device is herein collectively called the hand-held electronic device. The hand-held electronic device can be connected to one or more first external devices via an ad-hoc network protocol. As a result, the first external device can make use of the mobile broadband Internet access function of the hand-held electronic device to connect to the Internet. Thus, the first external devices can be connected to the Internet at the same time, hence providing the convenience of allowing multiple users of the first external devices to access Internet at the same time, and providing e.g. a benefit of reducing the fees for Internet access that are to be paid by each of the multiple users, as only one hand-held electronic device is needed to achieve the multiple-user Internet access. In addition, the hand-held electronic device may also connect with a second external device via an I/O interface to allow the second external device to be connected to the Internet as well.

A first example of the present invention is a hand-held electronic device. The hand-held electronic device includes a microprocessor and a modem unit. The microprocessor is used for connecting to at least one first external device via an ad-hoc network protocol. The modem unit is used for connecting to a base station to enable the first external device to communicate with the base station via the hand-held electronic device.

A second example of the present invention is a communication method applicable to a hand-held electronic device. The communication method includes the following steps. The hand-held electronic device is connected to at least one first external device via an ad-hoc network protocol. Then, the hand-held electronic device is connected to a base station. The first external device is enabled to communicate with the base station via the hand-held electronic device.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 shows a block diagram of a hand-held electronic device according to an embodiment of the invention;

FIG. 2 shows a flowchart illustrating a communication method applicable to the hand-held electronic device of FIG. 1 according to an embodiment of the invention; and

FIG. 3 shows a more detailed flowchart illustrating a communication method applicable to the hand-held electronic device of FIG. 1 according to an embodiment of the invention.

### DETAILED DESCRIPTION OF EXEMPLARY EMBODIMENT OF THE INVENTION

A hand-held electronic device or a mobile electronic device, such as a mobile phone, a PDA, or a smart phone, is disclosed as an embodiment of the invention. It's noted again that the mobile electronic device or the hand-held electronic device is herein collectively called the hand-held electronic device. The hand-held electronic device includes a microprocessor and a modem unit (a modulator-demodulator device). The user could achieve mobile broadband Internet access with the hand-held electronic device, so as to provide Internet access function to a second external device connected to an input/output (I/O) interface of the hand-held electronic device, or to provide Internet access function to at least one first external device connected to the hand-held electronic device via an ad-hoc network protocol.

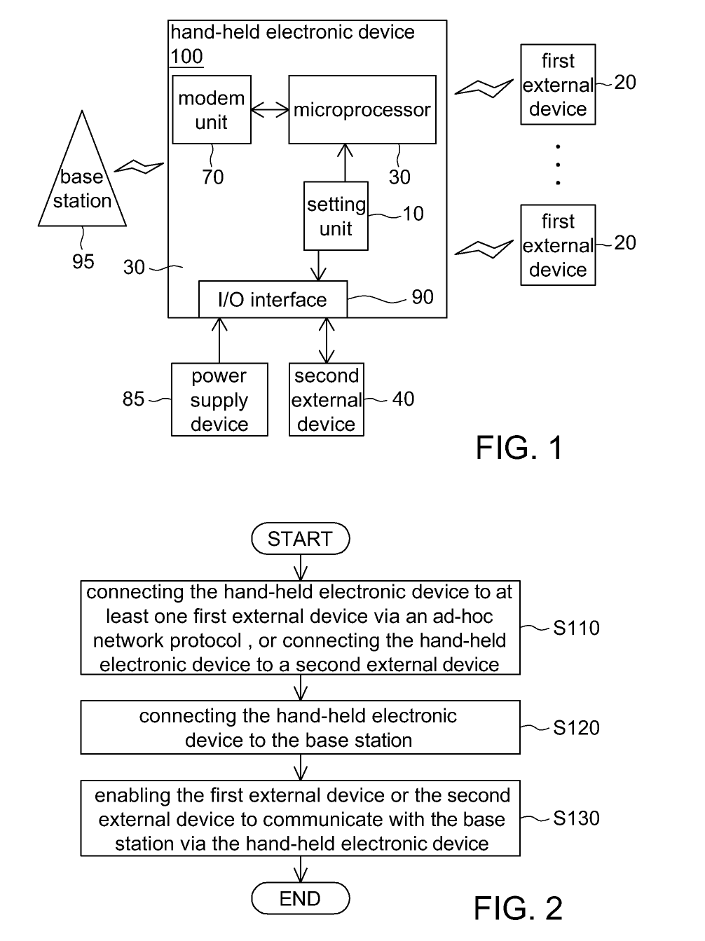

Referring to FIG. 1, a block diagram of a hand-held electronic device according to an embodiment of the invention is shown. The hand-held electronic device 100 includes a microprocessor 30 and a modem unit 70. The hand-held electronic device 100 may further include a setting unit 10 and an I/O interface 90. The microprocessor 30 is used for connecting to at least one first external device 20 via an ad-hoc network protocol. In an embodiment, the hand-held electronic device 100 communicates with the first external device 20 by for example the Bluetooth technology or the infrared data association (IrDA) technology. The setting unit 10 is used to set the microprocessor 30 to be connected to at least one first external device 20 via an ad-hoc network protocol. Or the setting unit 10 is used to set the microprocessor 30 to be connected to a second external device 40 through the I/O interface 90. The I/O interface 90 is, for example, a Universal Serial Bus (USB) interface.

Thus, multiple first external devices 20 can be connected to the hand-held electronic device 100 via the ad-hoc network protocol, so that the hand-held electronic device 100 can communicate with the first external devices 20 by wireless signal transmission. Also, the first external devices 20 may be mutually connected via for example an ad-hoc network protocol.

For example, one of the first external devices 20 may connect with another first external device 20 by Bluetooth technology or Infrared Data Association (IrDA) technology, so the first external device 20 may be not required to be connected to the hand-held electronic device 100 through IEEE (Institute of Electrical and Electronics Engineers) 802.11 standards.

The first external devices 20 can make use of the mobile broadband Internet access function of the hand-held electronic device 100 to connect to the Internet. Examples of the first external device 20 include a computer, a PDA and a mobile phone.

The modem unit 70 is used for connecting to a base station 95 to enable at least one first external device 20 to communicate with the base station 95 via the hand-held electronic device 100. The modem unit 70 may support the Point-to-Point protocol (PPP) and the base station 95 may support 3rd-Generation mobile communication (3 G) technologies and/or 3.5 G mobile communication technologies.

When the hand-held electronic device 100 is used to connect to multiple first external devices 20, the hand-held electronic device 100 would consume more power accordingly. Meanwhile, the hand-held electronic device 100 may further include a power supply device 85 connected to the I/O interface 90 for providing the hand-held electronic device 100 with power needed to ensure proper operation of the hand-held electronic device 100 under higher power consumption.

As indicated in FIG. 1, when the modem unit 70 receives a signal, the microprocessor 30 may receive and transmit the received signal to the first external device 20 by wireless transmission which may support the ad-hoc network protocol. When many users would like to be individually connected to the Internet via the respective first external devices 20 at the same time, only the hand-held electronic device 100 is required to connect to the Internet through for example the mobile broadband Internet access function of the hand-held electronic device 100, thereby the respective first external devices 20 being able to access the Internet through the hand-held electronic device 100 and the ad-hoc network protocol. Thus, the users can not only share in paying the fees for Internet access to reduce the cost as only one hand-held electronic device is required, but also can have the convenience of mobile accessing the Internet at anytime.

Referring to FIG. 1 again, the microprocessor 30 is used to be connected to the second external device 40 via the I/O interface 90. The second external device 40 can communicate with the base station 95 via the hand-held electronic device 100. When the modem unit 70 receives a signal, the microprocessor 30 may receive and further transmit the received signal to the second external device 40 through the I/O interface 90. Here, the second external device 40 may support for example the Universal Serial Bus (USB) standard. Examples of the second external device 40 include a computer, a mobile phone and a PDA.

Referring to FIG. 1 and FIG. 2, FIG. 2 shows a flowchart illustrating a communication method applicable to the hand-held electronic device of FIG. 1 according to an embodiment of the invention. In step S110, the hand-held electronic device 100 is connected to at least one first external device 20 via an ad-hoc network protocol, or connected to a second external device 40. Then in step S120, the hand-held electronic device 100 is connected to a base station 95 by for example a modem unit 70. Then in step S130, the first external device 20 or the second external device 40 is enabled, by for example the modem unit 70, to communicate with the base station 95 via the hand-held electronic device 100. A more detailed flowchart is further disclosed below.

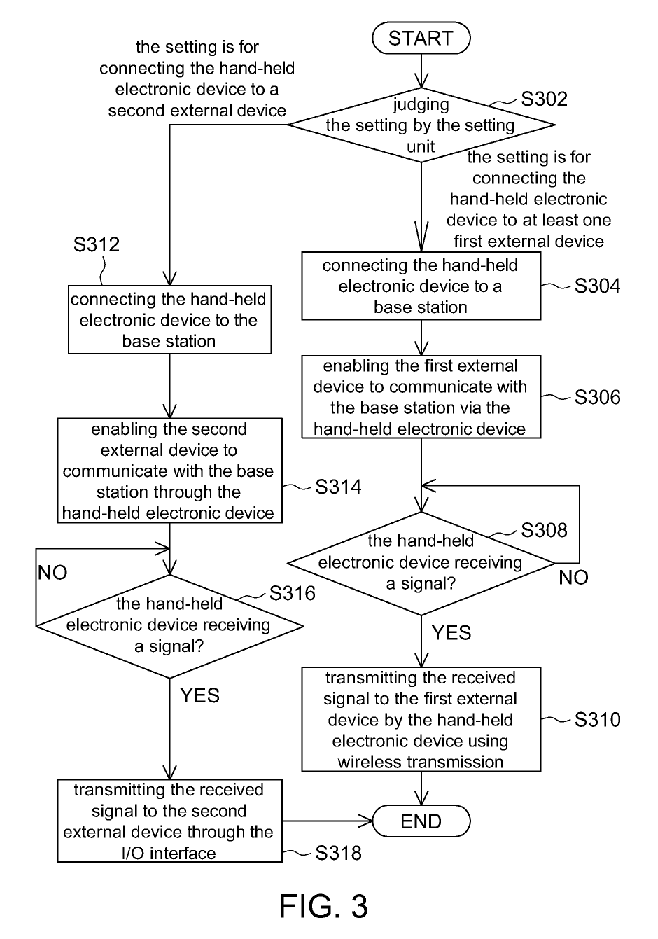

Referring to FIG. 3, a detailed flowchart illustrating a communication method applicable to the hand-held electronic device of FIG. 1 according to an embodiment of the invention is shown. In step S302, the setting by the setting unit 10 is judged, wherein the setting is that the hand-held electronic device 100 is set to connect to at least one first external device 20 via for example the ad-hoc network protocol or that the hand-held electronic device 100 is set to connect to the second external device 40 through for example the I/O interface 90. In an embodiment, the hand-held electronic device 100 is set to connect to the first external device 20 or the second external device 40 through a microprocessor 30 of the hand-held electronic device 100. If the hand-held electronic device 100 is set to connect to at least one first external device 20 via the ad-hoc network protocol, then step S304 is performed. If the hand-held electronic device 100 is set to connect to the second external device 40 through the I/O interface 90, then step S312 is performed.

In step S304, the hand-held electronic device 100 is connected to the base station 95 by for example the modem unit 70.

In step S306, the first external device 20 is enabled, by for example the modem unit 70, to communicate with the base station 95 via the hand-held electronic device 100.

In step S308, it's determined by for example the microprocessor 30 that whether the hand-held electronic device 100 receives a signal. If yes, then step S310 is performed; and if not, then step S308 is repeated.

In step S310, the hand-held electronic device 100 transmits the received signal to the first external device 20 by wireless transmission, wherein the signal may be received by for example the modem unit 70 of the hand-held electronic device 100.

In step S312, the hand-held electronic device 100 is connected to the base station 95 by for example the modem unit 70.

In step S314, the hand-held electronic device 100 is connected to the second external device 40 through for example the I/O interface 90.

In step S316, it is judged by for example the microprocessor 30 that whether the hand-held electronic device 100 receives a signal. If yes, then step S318 is performed; and if not, then step S318 is repeated.

In step S318, the hand-held electronic device 100 transmits the received signal to the second external device 40 through for example the I/O interface 90, wherein the signal is received by for example the modem unit 70 of the hand-held electronic device 100.

The hand-held electronic device and the communication method applicable thereto according to the embodiments of the invention enable multiple first external devices to connect to the Internet at the same time.

The hand-held electronic device is connected to the Internet first. Then, the first external devices, supporting the ad-hoc network protocol, are connected to Internet access at the same time via the hand-held electronic device by for example wireless transmission (such as the ad-hoc network protocol). Thus, the embodiments of the invention provide the convenience of allowing multiple users of the first external devices to access Internet at the same time, and provide e.g. a benefit of reducing the fees for Internet access that are to be paid by each of the multiple users, as only one hand-held electronic device is needed to achieve the multiple-user Internet access. Embodiments of the present invention have the potential for replacing conventional cabled broadband and are very competitive in the market.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A hand-held electronic device, comprising:
a microprocessor, for connecting to at least one first external device via an ad-hoc network protocol; and
a modem unit, for connecting to a base station to enable the first external device to communicate with the base station via the hand-held electronic device.

2. The hand-held electronic device according to claim 1, wherein the hand-held electronic device is used for communicating with the first external device by Bluetooth technology or Infrared Data Association (IrDA) technology.

3. The hand-held electronic device according to claim 1, wherein when the modem unit receives a signal, the microprocessor receives and transmits the received signal to the first external device by wireless transmission.

4. The hand-held electronic device according to claim 1, further comprising an input/output (I/O) interface, wherein the microprocessor is used to connect to a second external device through the I/O interface.

5. The hand-held electronic device according to claim 4, wherein the I/O interface is a Universal Serial Bus (USB) interface.

6. The hand-held electronic device according to claim 4, wherein, when the modem unit receives a signal, the microprocessor receives and further transmits the received signal to the second external device through the I/O interface.

7. The hand-held electronic device according to claim 4, further comprising a power supply device electrically connected to the I/O interface for providing power to the hand-held electronic device.

8. The hand-held electronic device according to claim 4, further comprising a setting unit used to set the microprocessor to be connected to the first external device via the ad-hoc network protocol or to set the microprocessor to be connected to the second external device through the I/O interface.

9. The hand-held electronic device according to claim 1, wherein the first external device supports the ad-hoc network protocol.

10. The hand-held electronic device according to claim 1, wherein the modem unit supports the Point-to-Point protocol (PPP).

11. A communication method applicable to a hand-held electronic device, comprising:
connecting the hand-held electronic device to at least one first external device via an ad-hoc network protocol, or connecting the hand-held electronic device to a second external device;
connecting the hand-held electronic device to a base station; and
enabling the first external device or the second external device to communicate with the base station via the hand-held electronic device.

12. The communication method according to claim 11, wherein the step of enabling the first external device or the second external device to communicate with the base station via the hand-held electronic device comprises the hand-held electronic device communicating with the first external device by Bluetooth technology or Infrared Data Association technology.

13. The communication method according to claim 11, further comprising:
when the hand-held electronic device receives a signal, transmitting the received signal to the first external device through wireless transmission.

14. The communication method according to claim 11, wherein the hand-held electronic device comprises an input/output (I/O) interface and the step of connecting the hand-held electronic device to the second external device is performed through the I/O interface.

15. The communication method according to claim 14, wherein the I/O interface is a Universal Serial Bus (USB) interface.

16. The communication method according to claim 14, further comprising:
when the hand-held electronic device receives a signal, transmitting the received signal to the second external device through the I/O interface.

17. The communication method according to claim 14, further comprising:
providing power to the hand-held electronic device through the I/O interface.

18. The communication method according to claim 11, wherein the hand-held electronic device is set to be connected to the first external device via the ad-hoc network protocol, or set to be connected to the second external device.

19. The communication method according to claim 11, wherein the first external device supports the ad-hoc network protocol.

20. The communication method according to claim 11, wherein the modem unit supports Point-to-Point protocol (PPP).
